(19) United States
(12) Patent Application Publication
(10) Pub. No.: US 2024/0309179 A1
(43) Pub. Date: Sep. 19, 2024

(54) FLAMEPROOF POLYAMIDE MOLDING COMPOUNDS FOR INSULATING ELECTRIC COMPONENTS

(71) Applicant: Evonik Operations GmbH, Essen (DE)

(72) Inventors: Alexey MERKULOV, Marl (DE); Mario RESING, Stadtlohn (DE); Juergen FRANOSCH, Marl (DE); Eckart RUBAN, Boeblingen (DE); Andreas SZENTIVANYI, Essen (DE); Duy Vu PHAM, Oberhausen (DE)

(73) Assignee: Evonik Operations GmbH, Essen (DE)

(21) Appl. No.: 18/572,864

(22) PCT Filed: Jun. 23, 2022
(86) PCT No.: PCT/EP2022/067108

§ 371 Date: Dec. 21, 2023

(30) Foreign Application Priority Data
Jun. 29, 2021 (EP) 21182247.3

(51) Int. Cl. C08K 5/521; C08K 5/053; C08K 5/3492; C08K 5/524

(52) U.S. Cl. CPC C08K 5/521; C08K 5/053; C08K 5/34924; C08K 5/524; C08K 2201/005; C08K 2201/019

(57) ABSTRACT

A flame-retardant polyamide molding compound may have low phosphorus content. Such a polyamide molding compound may include (A) a polyamide matrix including polyamide(s) having at least 8 carbon atoms per amide unit; (B) a flame retardant composition comprising (B1) metal-free aryl phosphate(s), (B2) aryl phosphonate(s), (B3) carbohydrate polyol(s), (B4) melamine cyanurate(s), and (B5) optionally, non-phosphorus-comprising flame retardant(s). A total phosphorus content from the flame retardant composition may be in a range of from 0.5 to 1.5 wt. %, based on total polyamide molding compound weight

The present invention relates to flame-retardant polyamide moulding compounds having a low phosphorus content.

EP 150511 A1 discloses pulverulent polyamide compositions comprising an alkyl phosphonate in the use for 3D printing.

EP 3127937 A1 demonstrates the effectiveness of metal phosphinates for providing polyamides with flame retardancy. According to the verbal evaluation of the examples, the addition of melamine cyanurate should be avoided.

EP 1731559 A1 proposes a phosphorus compound in combination with melamine cyanurate and an alcohol as flame retardant for polyamide. These achieve a UL 94 classification of V-0, but the comparative tests of the present invention demonstrate an increased loss of mass due to migration. Neither this loss of mass nor the elongation at break of the compositions were taken into account in EP 1731559 A1.

In US 2018/003771 A1 it is recommended that flame retardancy of polyamides be provided using melamine cyanurate and a polyol only. Mechanical requirements are not disclosed.

The object of the present invention was to provide polyamide moulding compounds that, with a low phosphorus content, exhibit very good flame retardancy and undergo only very low loss of mass at high temperatures; such moulding compounds should also be distinguished by high elongation at break.

It has surprisingly been found that flame retardants having a low content of phosphorus-containing compounds can be used with advantage for polyamide moulding compounds.

The present invention provides a polyamide moulding compound comprising:
(A) a polyamide matrix comprising one or more polyamides having at least 8 carbon atoms per amide unit,
(B) a flame retardant composition comprising:
   (B1) at least one metal-free aryl phosphate,
   (B2) at least one aryl phosphonate,
   (B3) a carbohydrate polyol,
   (B4) melamine cyanurate,
   (B5) optionally, non-phosphorus-containing flame retardants,
      wherein the content of phosphorus from the entire flame retardant composition is 0.5% to 1.5% by weight, preferably 0.75% to 1.25% by weight, based on the polyamide moulding compound.

The present invention further provides for the use of the polyamide moulding compound of the invention for the production of a component.

The present invention further provides a process for insulating current-bearing components.

The present invention further provides a hybrid component comprising a coated metal body, wherein the coating comprises a polyamide moulding compound.

The present invention further provides for the use of the hybrid components for the transmission of electric current, preferably in high-voltage and low-voltage systems, more preferably in high-voltage systems.

The polyamide moulding compounds of the invention, the hybrid components comprising the moulding compounds of the invention and the uses according to the invention are described hereinbelow by means of illustrative examples, without any intention that the invention be restricted to these illustrative embodiments. Where ranges, general formulas, or classes of compound are stated hereinbelow, these are intended to encompass not only the corresponding ranges or groups of compounds that are explicitly mentioned, but also all subranges and subgroups of compounds that can be obtained by taking out individual values (ranges) or compounds. Where documents are cited in the context of the present description, the entire content thereof is intended to be part of the disclosure content of the present invention. Where % values are given hereinbelow, these are values in % by weight unless otherwise stated. Percentage values for compositions are based on the total composition unless otherwise stated. Where average values are given hereinbelow, these are mass averages (weight averages) unless otherwise stated. Where measured values are given hereinbelow, these measured values were determined at a pressure of 101 325 Pa and at a temperature of 25° C. unless otherwise stated.

The scope of protection includes finished and packaged forms that are conventionally used in commerce for the products of the invention, not only per se but also in possible comminuted forms to the extent that these are not defined in the claims.

The optionally different units of the polyamides follow a statistical distribution. Statistical distributions are of blockwise construction with any desired number of blocks and with any desired sequence or they are subject to a randomized distribution; they may also have an alternating construction or else form a gradient over the polymer chain; in particular they can also form any mixed forms in which groups with different distributions may optionally follow one another. Specific embodiments may result in statistical distributions being restricted as a consequence of the embodiment. For all regions unaffected by the restriction, the statistical distribution is unchanged.

An advantage of the polyamide moulding compounds of the invention is that they have very good fire protection, with a UL 94 fire classification of V-0.

A further advantage of the polyamide moulding compounds of the invention is that they have a high elongation at break.

A further advantage of the polyamide moulding compounds of the invention is that only very low migration of low-molecular-weight constituents occurs at the surface (efflorescence, loss of mass) after storage at high temperature for a relatively long period.

A further advantage of the polyamide moulding compounds of the invention is that there is no loss of flame retardancy through loss of mass due to migration.

A further advantage is the particularly good adhesion of the polyamide moulding compounds of the invention to metallic surfaces.

### Polyamide Matrix (A)

Preferably, the polyamides of the polyamide matrix (A) have, as a statistical average over the polymer, 8 to 16 carbon atoms, more preferably 9 to 14 carbon atoms, particularly preferably 10 to 12 carbon atoms per amide unit. More preferably, the polyamides of the polyamide matrix (A) have in all monomer units at least 8 carbon atoms per amide unit.

The polyamides may be homopolymers, copolymers or blends of different polyamides. The differences in the polyamides may be manifested for example in the use of different monomers in the polymerization, different molar mass distribution (which can be manifested in, for example, different viscosities) or different end groups.

Preference is given to polyamides selected from PA 8, PA 9, PA 10, PA 11, PA 12, PA 6.10, PA 6.12, PA 6.14, PA 8.10, PA 9.10, PA 9.12, PA 10.10, PA 10.12, PA 12.12, PA 6.16, PA 10.16; more preferably PA 6.12, PA 10.10, PA 10.12, PA 11 and PA 12; particularly preferably PA 11 and PA12.

The polyamide moulding compound preferably does not contain any other polyamide besides the polyamides of the polyamide matrix (A).

### Flame Retardant Composition (B)

The flame retardant composition of the polyamide moulding compound of the invention preferably comprises
15% to 55% by weight, preferably 25% to 50% by weight, more preferably 30% to 45% by weight, of melamine cyanurate (B4);
10% to 30% by weight, preferably 15% to 25% by weight, more preferably 17% to 23% by weight, of carbohydrate polyol (B3);
5% to 30% by weight, preferably 7% to 25% by weight, more preferably 13% to 23% by weight, of aryl phosphonate (B2);
5% to 30% by weight, preferably 7% to 25% by weight, more preferably 13% to 23% by weight, of metal-free aryl phosphate (B1);
0% to 15% by weight, preferably 3% to 12% by weight, more preferably 5% to 10% by weight, of a non-phosphorus-containing flame retardant (B5);
   wherein the sum of (B1), (B2), (B3), (B4) and (B5) gives 100% by weight of component (B).

In the flame retardant composition of the polyamide moulding compound of the invention, the mass ratio of (B1) to (B2) is preferably 0.25 to 4, preferably 0.33 to 3, more preferably 0.5 to 2, particularly preferably 0.75 to 1.5.

The non-phosphorus-containing flame retardants (B5) are different from the flame retardants according to B3 and B4. Preference is given to urea and urea derivatives, magnesium hydroxides, aluminium hydroxides, aluminium sulfate, borax, boric acid and salts of boric acid (e.g. zinc borate), ammonium sulfate and calcium hydroxides. Halogenated flame retardants may also be added.

Preferably, the non-phosphorus-containing flame retardants (B5) contain no halogenated substances.

Melamine cyanurate (B4) is also understood as meaning melamine condensation products, melem, melam, melon, but preferably exclusively melamine cyanurate (CA-RN 37640-57-6) itself. The melamine cyanurate is used in powder form. It preferably has a particle size D50, measured by laser diffraction using a laser granulometer in accordance with BS ISO 13320-1, version 2000-03-15, of from 0.5 to 100 μm, more preferably from 0.6 to 50 μm, particularly preferably from 0.7 to 25 μm, very particularly preferably from 0.8 to 5 μm and especially preferably from 0.9 to 4 μm. The measurement is preferably carried out using a Cilas 715/920 laser granulometer. Small particle sizes are preferred as they give mouldings a smoother finish.

The carbohydrate polyol (B3) is preferably a hydrocarbon substituted with at least 3, preferably at least 4, more preferably at least 5, even more preferably at least 6, hydroxy groups and optionally contains ether groups, preferably having at least one ether group.

The carbohydrate polyol is more preferably selected from a triol such as trimethylolpropane or glycerol or a derivative thereof such as ditrimethylolpropane or diglycerol (formed through monoetherification of two molecules of the cited compounds) or a tetrol such as erythritol, pentaerythritol or an ether-group-containing derivative thereof such as di- or tripentaerythritol, a pentol such as xylitol or arabitol, a hexol such as mannitol, sorbitol or the like; in addition it is also possible to use higher adducts of the cited molecules, for example a branched or hyperbranched polyglycerol; it is of course possible to use mixtures of polyols too. Greater preference is given to erythritol, pentaerythritol or di- or tripentaerythritol, in particular dipentaerythritol.

Aryl phosphonates (B2) are for the purposes of the invention polymers or oligomers having at least 3 repeat units, preferably 3 identical repeat units, and contain aromatic substituents in the backbone of the molecule.

The aryl phosphonate preferably contains the repeat unit shown in formula (III)

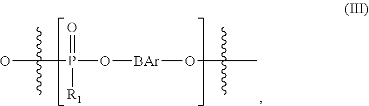

where R1 is in each case independently an alkyl radical having 1 to 4 carbon atoms, preferably methyl, and
where BAr is in each case independently an aromatic radical, preferably an aromatic radical having at least two rings, more preferably biphenylene or 4,4′-(propane-2,2-diyl)diphenylene.

Preferably, the aryl phosphonate contains the —BAr—OH group as end groups.

Particularly preferably, the aryl phosphonate contains the repeat unit shown in formula (IV)

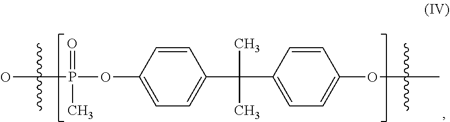

accordingly the aryl phosphonate preferably contains bisphenol A end groups.

The aryl phosphonate has preferably an MVR (melt volume rate) of less than 100 ml/10 min and more preferably an MVR of at least 10 ml/10 min, even more preferably of at least 25 ml/10 min, particularly preferably of at least 50 ml/10 min and especially preferably of 65 to 90 ml/10 min (measured at 240° C. and a loading of 1.2 kg, in accordance with ISO 1133).

The metal-free aryl phosphate (B1) preferably contains at least 2 phosphate groups.

More preferably, the metal-free aryl phosphate contains at least one unit of formula (I), preferably 1 or 2 of said units

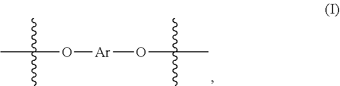

and at least two units, preferably two or three units, of formula (II),

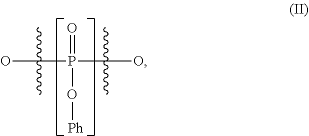

wherein the units of formula (I) or (II) are present in alternation, wherein the number of units according to formula (II) is always 1 greater than the number of formula (I),
where Ar is ortho-, meta-, para-phenylene, naphthylene or biphenylene,
where Ph is a phenyl radical, optionally having any desired substitution with C1 to C4 alkyl radicals.

Preferably, the metal-free aryl group contains, as end groups, phenyl radicals, which may have any desired substitution with C1 to C4 alkyl radicals.

More preferably, the metal-free aryl phosphate contains structural elements of formula (V)

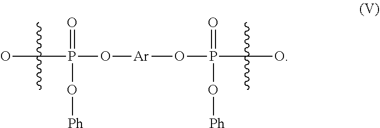

Particularly preferably, the metal-free aryl phosphate contains the structure of formula (VI)

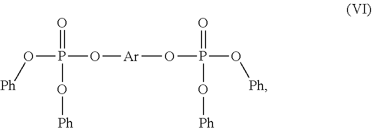

where Ar is meta- or para-phenylene and Ph is phenyl.

Preferably, Ar is not a 4,4′-(propane-2,2-diyl)diphenylene radical.

The flame retardant composition preferably does not contain any polyphosphates, any products of the reaction of melamine with polyphosphoric acid or any derivatives of phosphoric(III) acid and/or phosphoric(I) acid.

The flame retardant composition preferably does not contain any further phosphorus-containing components apart from components (B1) and (B2).

A preferred combination for the flame retardant composition (B) is:
at least one metal-free aryl phosphate (B1) containing at least one unit of formula (I), preferably 1 or 2 of said units

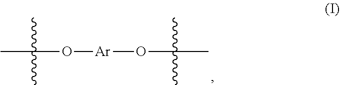

and at least two units, preferably two or three units, of formula (II),

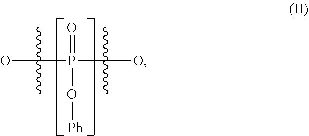

wherein the units of formula (I) or (II) are present in alternation,
wherein the number of units according to formula (II) is always 1 greater than the number of formula (I),
where Ar is ortho-, meta-, para-phenylene, naphthylene or biphenylene, but not a 4,4′-(propane-2,2-diyl)diphenylene radical,
where Ph is a phenyl radical, optionally having any desired substitution with C1 to C4 alkyl radicals;
at least one aryl phosphonate (B2) containing the repeat unit of formula (IV)

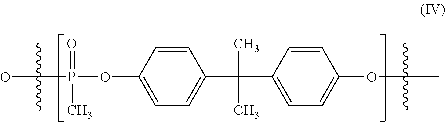

and bisphenol A as end group;
carbohydrate polyol (B3), which is substituted with at least 3, preferably at least 4, more preferably at least 5, even more preferably at least 6, hydroxy groups and optionally contains ether groups, preferably having at least one ether group;
melamine cyanurate (B4);
and, optionally, non-phosphorus-containing flame retardants (B5) selected from urea and urea derivatives, magnesium hydroxides, aluminium hydroxides, aluminium sulfate, borax, boric acid and salts of boric acid (e.g. zinc borate), ammonium sulfate, calcium hydroxides, optionally also halogenated flame retardants.

A more preferred combination for the flame retardant composition (B) is:
at least one metal-free aryl phosphate (B1) containing structural elements of formula (V)

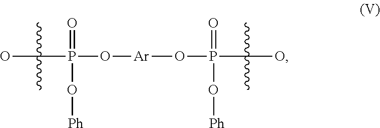

where Ar is ortho-, meta-, para-phenylene, naphthylene or biphenylene, but not a 4,4′-(propane-2,2-diyl)diphenylene radical,
where Ph is a phenyl radical, optionally having any desired substitution with C1 to C4 alkyl radicals;
at least one aryl phosphonate (B2) containing the repeat unit of formula (IV)

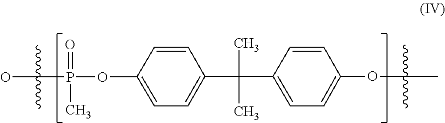

and bisphenol A as end group;
carbohydrate polyol (B3), which is substituted with at least 3, preferably at least 4, more preferably at least 5, even more preferably at least 6, hydroxy groups and optionally contains ether groups, preferably having at least one ether group;
melamine cyanurate (B4) having a particle size D50, measured by laser diffraction using a laser granulometer in accordance with BS ISO 13320-1, version 2000-03-15, of from 0.5 to 100 μm, more preferably from 0.6 to 50 μm, particularly preferably from 0.7 to 25 μm, very particularly preferably from 0.8 to 5 μm and especially preferably from 0.9 to 4 μm;
and, optionally, non-phosphorus-containing flame retardants (B5) selected from urea and urea derivatives, magnesium hydroxides, aluminium hydroxides, aluminium sulfate, borax, boric acid and salts of boric acid (e.g. zinc borate), ammonium sulfate, calcium hydroxides, optionally also halogenated flame retardants;
having a mass ratio of (B1) to (B2) of 0.25 to 4, preferably 0.33 to 3, more preferably 0.5 to 2, particularly preferably 0.75 to 1.5.

A particularly preferred combination for the flame retardant composition (B) is:
5% to 30% by weight of at least one metal-free aryl phosphate (B1) containing the structure of formula (VI)

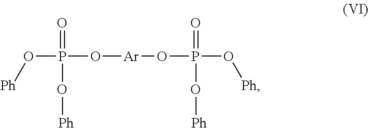

where Ar is meta- or para-phenylene,
where Ph is a phenyl radical, optionally having any desired substitution with C1 to C4 alkyl radicals;
5% to 30% by weight of at least one aryl phosphonate (B2) containing the repeat unit of formula (IV)

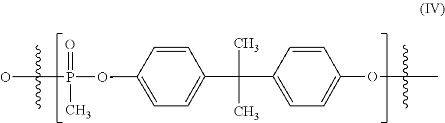

and bisphenol A as end group;
10% to 30% by weight of carbohydrate polyol (B3), which is substituted with at least 3, preferably at least 4, more preferably at least 5, even more preferably at least 6, hydroxy groups and preferably having at least one ether group;
15% to 55% by weight of melamine cyanurate (B4) having a particle size D50, measured by laser diffraction using a laser granulometer in accordance with BS ISO 13320-1, version 2000-03-15, of from 0.5 to 100 μm, more preferably from 0.6 to 50 μm, particularly preferably from 0.7 to 25 μm, very particularly preferably from 0.8 to 5 μm and especially preferably from 0.9 to 4 μm;
and 0% to 15% by weight of non-phosphorus-containing flame retardants (B5) selected from urea and urea derivatives, magnesium hydroxides, aluminium hydroxides, aluminium sulfate, borax, boric acid and salts of boric acid (e.g. zinc borate), ammonium sulfate, calcium hydroxides;
wherein the sum of (B1), (B2), (B3), (B4) and (B5) gives 100% by weight of component (B);
having a mass ratio of (B1) to (B2) of 0.25 to 4, preferably 0.33 to 3, more preferably 0.5 to 2, particularly preferably 0.75 to 1.5.

Preferably, the polyamide moulding compound of the invention comprises, besides the phosphorus-containing flame retardants, not more than 5000 ppm, preferably not more than 1000 ppm, more preferably not more than 500 ppm, especially preferably not more than 250 ppm, of phosphorus from other sources, for example from stabilizers, processing aids or catalysts.

Optionally, the polyamide moulding compounds of the invention comprise customary processing aids such as stabilizers, oxidation retardants, other agents protecting against thermal decomposition and decomposition by ultraviolet light, lubricants and mould-release agents, colouring agents such as dyes and pigments, nucleating agents, plasticizers, etc.

Optionally, the polyamide moulding compounds of the invention comprise, besides the described components, further additives selected from one or more representatives, optionally two or more of the same kind, such as stabilizers, other polymers, impact modifiers, plasticizers, colouring agents such as pigments and dyes, processing aids.

Suitable oxidation stabilizers are aromatic amines, sterically hindered phenols, hydroquinones, phosphites, phosphonites, thiosynergists, hydroxylamines, benzofuranone derivatives, acryloyl-modified phenols etc. A great many types of such oxidation stabilizers are commercially available, for example under the trade names Naugard 445, Irganox 1010, Irganox 1098, Irgafos 168, P-EPQ or Lowinox DSTDP. In general, the moulding compounds comprise about 0.01% to about 2% by weight and preferably about 0.1% to about 1.5% by weight of oxidation stabilizers.

In addition, the moulding compounds may also comprise UV stabilizers or light stabilizers. Suitable UV stabilizers are organic UV absorbers, for example benzophenone derivatives, benzotriazole derivatives, resorcinols, salicylates, oxalanilides and phenyltriazines. Light stabilizers of the HALS type are tetramethylpiperidine derivatives. UV stabilizers and light stabilizers may advantageously be used in combination. A great many types of both are commercially available; the manufacturer's instructions can be followed in respect of the dosage.

In addition, the moulding compounds may comprise hydrolysis stabilizers, for instance a monomeric, oligomeric or polymeric carbodiimide or bisoxazoline.

Examples of other polymers that may be present in the moulding compositions as additive are polyetheramides, or polytetrafluoroethylene (PTFE).

Impact modifiers are known to those skilled in the art. They contain functional groups which originate from unsaturated functional compounds that are either incorporated into the main chain polymer or grafted onto the main chain. The most commonly used are EPM or EPDM rubber that has undergone free-radical grafting with maleic anhydride. Rubbers of this kind can also be used together with an unfunctionalized polyolefin, for example isotactic polypropylene, as described in EP-A-0 683 210.

Plasticizers are known to those skilled in the art from Gächter/Müller, Kunststoff additive [Plastics additives], C. Hanser Verlag, 2nd edition, p. 296. Examples of customary compounds suitable for use as plasticizers are esters of p-hydroxybenzoic acid having 2 to 20 carbon atoms in the alcohol component or amides of arylsulfonic acids having 2 to 12 carbon atoms in the amine component, preferably amides of benzenesulfonic acid. Useful plasticizers include ethyl p-hydroxybenzoate, octyl p-hydroxybenzoate, i-hexadecyl p-hydroxybenzoate, N-n-octyltoluenesulfonamide, N-n-butylbenzenesulfonamide or N-2-ethylhexylbenzenesulfonamide.

Examples of suitable pigments and/or dyes are mixed oxides, titanium dioxide, iron oxide, zinc sulfide, ultramarine, nigrosin, organic pigments, such as phthalocyanines, quinacridones, perylene, nigrosin, anthraquinones, pearlescent pigments.

Examples of suitable processing aids are paraffins, fatty alcohols, fatty acid amides, stearates such as calcium stearate, paraffin waxes, montanates or polysiloxanes.

The polyamide moulding compounds of the invention preferably contain no halogenated substances.

The moulding compounds of the invention have a UL 94 fire classification of VO. This classification is made according to the UL guidelines, but preferably in accordance with DIN EN 60695-11-10:2014 on test specimens having the dimensions 125 mm*13 mm*0.8 mm, taking into account revision 1 (October 2015) of the above standard.

The moulding compounds of the invention preferably have an elongation at break of at least 50%, preferably at least 100%, more preferably at least 150% and especially preferably at least 200%. The elongation at break is measured on type 1A tensile specimens (DIN EN ISO 527-2) in accordance with DIN EN ISO 527-1.

The moulding compounds of the invention preferably exhibit only very low migration of low-molecular-weight constituents after storage at high temperature for a relatively long period. For this, test specimens having the dimensions 125 mm*13 mm*0.8 mm were stored at 150° C. for 24 h and the amount of material that had migrated was determined. The method of determination is elucidated in more detail in the examples. The loss of mass due to migration is preferably less than 1.1% by weight, more preferably less than 1.0% by weight and particularly preferably less than 0.9% by weight, based on the total moulding compound.

Preferably, the moulding compounds of the invention have a UL 94 classification of V-0, a loss of mass due to migration of less than 1.1% by weight and an elongation at break of at least 50%.

The polyamide moulding compounds of the invention preferably contain no additives that increase electrical conductivity, in particular no conductive carbon blacks or carbon nanotubes.

A preferred polyamide moulding compound comprises:
(A) a polyamide matrix comprising one or more polyamides having, as a statistical average over the polymer, 8 to 16 carbon atoms, more preferably 9 to 14 carbon atoms, particularly preferably 10 to 12 carbon atoms per amide unit;
(B) a flame retardant composition comprising:
   (B1) at least one metal-free aryl phosphate containing structural elements of formula (V);

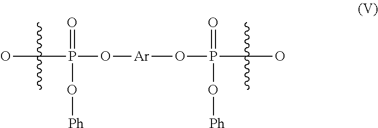

where Ar is ortho-, meta-, para-phenylene, naphthylene or biphenylene, but not a 4,4′-(propane-2,2-diyl)diphenylene radical,
where Ph is a phenyl radical, optionally having any desired substitution with C1 to C4 alkyl radicals;
(B2) at least one aryl phosphonate containing repeat units of formula (IV);

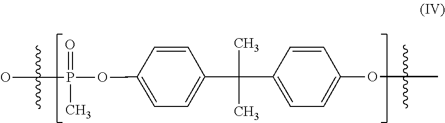

and bisphenol A as end group;
(B3) a carbohydrate polyol, which is substituted with at least 3, preferably at least 4, more preferably at least 5, even more preferably at least 6, hydroxy groups and optionally contains ether groups, preferably having at least one ether group;
(B4) melamine cyanurate having a particle size D50, measured by laser diffraction using a laser granulometer in accordance with BS ISO 13320-1, version 2000-03-15, of from 0.5 to 100 μm, more preferably from 0.6 to 50 μm, particularly preferably from 0.7 to 25 μm, very particularly preferably from 0.8 to 5 μm and especially preferably from 0.9 to 4 μm;
(B5), optionally, non-phosphorus-containing flame retardants selected from urea and urea derivatives, magnesium hydroxides, aluminium hydroxides, aluminium sulfate, borax, boric acid and salts of boric acid (e.g. zinc borate), ammonium sulfate, calcium hydroxides, optionally also halogenated flame retardants;
having a mass ratio of (B1) to (B2) of 0.25 to 4, preferably 0.33 to 3, more preferably 0.5 to 2, particularly preferably 0.75 to 1.5;
wherein the content of phosphorus from the entire flame retardant composition is 0.5% to 1.5% by weight based on the polyamide moulding compound.

A likewise preferred polyamide moulding compound comprises:
(A) a polyamide matrix comprising one or more polyamides selected from PA 8, PA 9, PA 10, PA 11, PA 12, PA 6.10, PA 6.12, PA 6.14, PA 8.10, PA 9.10, PA 9.12, PA 10.10, PA 10.12, PA 12.12, PA 6.16, PA 10.16; more preferably PA 6.12, PA 10.10, PA 10.12, PA 11 and PA 12; particularly preferably PA 11 and PA12;
(B) a flame retardant composition comprising:
   (B1) at least one metal-free aryl phosphate containing at least one unit of formula (I), preferably 1 or 2 of said units

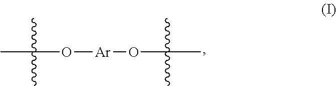

and at least two units, preferably two or three units, of formula (II),

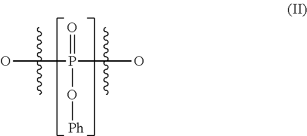

wherein the units of formula (I) or (II) are present in alternation,
wherein the number of units according to formula (II) is always 1 greater than the number of formula (I),
where Ar is ortho-, meta-, para-phenylene, naphthylene or biphenylene, but not a 4,4′-(propane-2,2-diyl)diphenylene radical,
where Ph is a phenyl radical, optionally having any desired substitution with C1 to C4 alkyl radicals;
(B2) at least one aryl phosphonate containing repeat units of formula (IV);

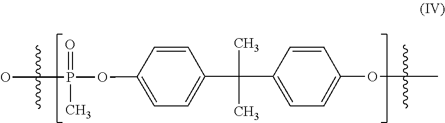

and bisphenol A as end group;
(B3) a carbohydrate polyol, which is substituted with at least 3, preferably at least 4, more preferably at least 5, even more preferably at least 6, hydroxy groups and optionally contains ether groups, preferably having at least one ether group;
(B4) melamine cyanurate,
(B5), optionally, non-phosphorus-containing flame retardants selected from urea and urea derivatives, magnesium hydroxides, aluminium hydroxides, aluminium sulfate, borax, boric acid and salts of boric acid (e.g. zinc borate), ammonium sulfate, calcium hydroxides, optionally also halogenated flame retardants;
having a mass ratio of (B1) to (B2) of 0.25 to 4, preferably 0.33 to 3, more preferably 0.5 to 2, particularly preferably 0.75 to 1.5;
wherein the content of phosphorus from the entire flame retardant composition is 0.5% to 1.5% by weight based on the polyamide moulding compound.

A further preferred polyamide moulding compound comprises:
(A) a polyamide matrix comprising one or more polyamides having, as a statistical average over the polymer, 8 to 16 carbon atoms, more preferably 9 to 14 carbon atoms, particularly preferably 10 to 12 carbon atoms per amide unit;
(B) a flame retardant composition comprising:
   (B1) at least one metal-free aryl phosphate containing at least one unit of formula (I), preferably 1 or 2 of said units

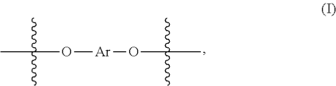

and at least two units, preferably two or three units, of formula (II),

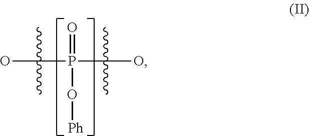

wherein the units of formula (I) or (II) are present in alternation,
wherein the number of units according to formula (II) is always 1 greater than the number of formula (I),
where Ar is ortho-, meta-, para-phenylene, naphthylene or biphenylene, but not a 4,4′-(propane-2,2-diyl)diphenylene radical,
where Ph is a phenyl radical, optionally having any desired substitution with C1 to C4 alkyl radicals;
(B2) at least one aryl phosphonate containing repeat units of formula (IV);

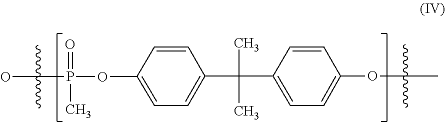

and bisphenol A as end group;
(B3) a carbohydrate polyol, which is substituted with at least 3, preferably at least 4, more preferably at least 5, even more preferably at least 6, hydroxy groups and optionally contains ether groups, preferably having at least one ether group;
(B4) melamine cyanurate,
(B5), optionally, non-phosphorus-containing flame retardants selected from urea and urea derivatives, magnesium hydroxides, aluminium hydroxides, aluminium sulfate, borax, boric acid and salts of boric acid (e.g. zinc borate), ammonium sulfate, calcium hydroxides, optionally also halogenated flame retardants;
having a mass ratio of (B1) to (B2) of 0.25 to 4, preferably 0.33 to 3, more preferably 0.5 to 2, particularly preferably 0.75 to 1.5;
wherein the content of phosphorus from the entire flame retardant composition is 0.5% to 1.5% by weight based on the polyamide moulding compound;
wherein the moulding compound has a UL 94 classification of V-0, a loss of mass due to migration of less than 1.1% by weight and an elongation at break of at least 50%.

The present invention relates to the use of the polyamide moulding compounds of the invention for the production of components, and to the components themselves, in particular for uses as fire protection in the automotive sector, preferably as a coating, covering, film, profile, tube, corrugated tube, hollow body, seal, cladding, bracket, housing, sheathing, electrical components and electronic components such as preferably current-bearing metal parts.

In the process of the invention for the insulation of current-bearing components, the components are preferably produced by compression-moulding, foaming, extrusion, coextrusion, blow moulding, 3D blow moulding, coextrusion blow moulding, coextrusion 3D blow moulding, coextrusion suction blow moulding, extrusion coating, powder coating or injection moulding. Processes of this kind are known to those skilled in the art.

Preferably, the hybrid components of the invention comprise a coated metal body, wherein the coating comprises a polyamide moulding compound comprising:
(A) a polyamide matrix comprising one or more polyamides having at least 8 carbon atoms per amide unit,
(B) a flame retardant composition comprising:
   (B1) at least one metal-free aryl phosphate,
   (B2) at least one aryl phosphonate,
   (B3) a carbohydrate polyol,
   (B4) melamine cyanurate,
   (B5) optionally, non-phosphorus-containing flame retardant,
      wherein the content of phosphorus from the entire flame retardant composition is 0.5% to 1.5% by weight, preferably 0.75% to 1.25% by weight, based on the polyamide moulding compound. The constituents of the polyamide moulding compound are described above.

Preferably, the non-phosphorus-containing flame retardants (B5) contain no halogenated flame retardants. More preferably, the entire coating contains no halogenated substances. This is associated with the advantage of better corrosion protection and also better environmental compatibility; it is also not possible for halogen-containing substances to be emitted even in the case of extreme heating such as a metal fire.

The present invention also relates to a process for producing a component of this kind. The process is characterized in that the polyamide moulding compound is formed into the component in an extrusion process or blow extrusion process, an injection-moulding process or an insert moulding.

Particularly in the case of hybrid components, these may be formed after the coating of the metal body. It is also possible for further attachments, for example plugs and sockets, screw connections, connecting elements, to be fitted to the hybrid components.

During forming, the polyamide moulding compounds of the invention have the advantageous feature of very good mouldability, which means that no detachments, cracks, shrinkage wrinkles and similar effects occur in the coating of the polyamide moulding compound (hereinafter also referred to simply as polyamide coating) during the forming of a hybrid component.

In particular, their good formability ensures that the polyamide coating provides effective electrical insulation, particularly in the high-voltage range. In the high-voltage range, large amounts of charge are transported over long periods of time. In this context, a notable feature of the coating with the moulding compounds of the invention is excellent temperature stability. This is manifested in two ways: Firstly, no significant loss of mass due to migration occurs. This preserves the good insulation properties between the outside world and the current-bearing metal, as well as on the surface of the polyamide coating (prevention of leakage current). Secondly, even after a long time and high temperatures the polyamide coatings remain mechanically stable, for example to vehicle vibrations, which means that-particularly in the abovementioned formed bodies-cracks do not develop, which reduce the insulation effect in particular.

The hybrid components of the invention may be used with preference in vehicles, vehicles being understood as meaning all means of transport, i.e. by water, land, air and space. The hybrid components are used for example for charge transfer in the power supply, both within the component generating the current and for transmission to the recipient. Preferred uses are use in electrically powered vehicles, for example the connection in series or parallel of electricity storage systems or electricity generators, the transfer of charge from the electricity storage system or generator system to the drive unit, the transfer of charge to further electricity-consuming systems, preferably in high-voltage systems.

The hybrid components of the invention may further be used with preference also in fixed systems, such as power plants: wind turbines, fuel cells or electrolysis cells, hydroelectric power stations or other power stations, or in intermediate processors such as substations and the like, or in transmission installations such as cable systems and line systems in the ground, under water or in structures, e.g. bridges, the latter in particular being exposed to the weather and vibrations from use.

Values for the phosphorus content in the articles of the invention refer to the content of phosphorus as the element.

### Methods

Differential scanning calorimetry (DSC):

DSC measurements were carried out in accordance with DIN EN ISO 11357-1: 2016.

Relative solution viscosity (ηᵣₑₗ):

The samples are dissolved in m-cresol at 30° C. (0.005 g/ml) and measured in a viscosity measurement system (LAUDA PVS or Schott AVS Pro) at 25.00° C.

The moulding compounds of the invention have a UL 94 fire classification of V-0. The classification is made according to the UL guidelines, but preferably in accordance with DIN EN 60695-11-10:2014 on test specimens having the dimensions 125 mm*13 mm*0.8 mm, taking into account revision 1 (October 2015) of the above standard.

To determine the loss of mass due to migration, a specimen (125 mm*13 mm*0.8 mm) is weighed out at 23° C. and then thermally treated at 150° C. in an oven in accordance with IEC 60216-4 for 24 h. The bar is then cooled at 23° C. for 30 min and mechanically cleaned with an acetone wet wipe until no coating that can be wiped off is present (mirror sample). The bar is then dried at 23° C. for 15 min and any electrostatic charge discharged using an ionizer. The loss of mass is calculated as an average value of three samples by repeat weighing. The negative value thereof is designated the loss of mass due to migration.

The elongation at break is carried out in accordance with DIN EN ISO 527-1. Dumbbell specimens A1 according to part 2 of the cited standard were used. The measurements were carried out at 23° C. with a speed of 50 mm/min.

The elongation at break is of particular importance in the context of the present invention, since use as an electrical insulator for the sheathing of electrical conductors, especially in the high-voltage range, must meet particularly high requirements. These conductors are bent by up to 180º and it must be ensured that the insulator exhibits no cracks, since these would act as current bridges. It is self-explanatory that these requirements, e.g. in automotive applications, must be met with the utmost certainty in order not to endanger people working in the engine compartment.

### Materials:

PA 6.10: moderately viscous

PA 6.12: moderately viscous

PA 10.12: moderately viscous

PA 12: highly viscous

PA 12/6: moderately viscous

Melamine cyanurate (MC), Melapur MC 25 (BASF)

Dipentaerythritol, from Perstorp

Fyrolflex® Sol-DP and ˜RDP, trademarks of ICL IP America Inc., USA

ADK STAB FP-600, product from Adeka, Polymer Additives Europe, France

Disflamoll® DPK, trademark of Lanxess, Germany

Aflammit® PCO 900, trademark of Thor Specialties Limited, United Kingdom

Amgard® CU, trademark of Lanxess, Germany

Nofia® HM7000, trademark of FRX polymers, Inc., USA

The stabilizer mixture comprises impact modifiers, stabilizers (heat and/or oxidation) and dyes/pigments.

### EXAMPLE 1: GENERAL PROCEDURE FOR COMPOUNDING POLYAMIDE MOULDING COMPOUNDS

The moulding compounds were produced on a co-rotating twin-screw extruder. The solid components were metered in via the main feeder and the liquid components metered into the melt downstream thereof. The housing temperatures are listed in Table 1. Pelletization was by strand pelletization with subsequent drying in a dry-air-chamber dryer for 12 hours at 80° C.

### EXAMPLE 2: PRODUCTION OF THE TEST SPECIMENS

The test specimens were produced by the injection-moulding method in accordance with DIN EN ISO 294-1 and DIN EN ISO 16396-2. The injection rate was 200 mm/s, the temperature of the compounds was in all cases 240° C., the corresponding mould temperatures are shown in Table 1. The following samples were realized for the determination of typical material properties:
Multipurpose test specimens in accordance with DIN EN ISO 527-2 type 1A for mechanical tests
UL 94 test specimens 172 mm×12.7 mm×0.8 mm for UL 94V and loss of mass due to migration
Plates for electrical measurements 130 mm×130 mm×1 mm.

### EXAMPLE 3: MECHANICAL AND ELECTRICAL TESTS

The elongation at break was determined in accordance with DIN EN ISO 527-1.

The dielectric strength was determined in accordance with DIN EN 60243-1, AC K20/K20.

TABLE 1
Production parameters (temperatures in ° C.) for examples 2

| | Moulding compound | Injection mould |
|---|---|---|
| Ex. 1, 4 and 5 | 260 | 80 |
| Ex. 2, 3, 7, 14-19 | 250 | 80 |
| Ex. 6 | 220 | 80 |
| Ex. 8 and 9 | 260 | 60 |
| Ex. 10-13 | 240 | 80 |

TABLE 2
Results of the tests as per example 3
on the test specimens as per example 2

| | | Elongation | | Dielectric |
|---|---|---|---|---|
| | | at break | | strength |
| | UL 94 | [%] | Migration [%] | [MV/m] |
| Ex. 1 | V-0 | 5.9 | 2.64 | 30.7 |
| Ex. 2 | V-0 | 51.3 | 0.97 | 28.6 |
| Ex. 3 | V-0 | 55.1 | 1.84 | 30.9 |
| Ex. 4 | V-0 | 75.7 | 2.21 | 31.5 |
| Ex. 5 | V-0 | 251.6 | 1.51 | 29.1 |
| Ex. 6 | V-0 | 320.6 | 3.61 | 33.2 |
| Ex. 7 | V-0 | 243.6 | 0.79 | 35.3 |
| Ex. 8 | V-0 | 230.3 | 1.35 | 28.6 |
| Ex. 9 | V-0 | 213.5 | 0.89 | 28.5 |
| Ex. 10 | V-0 | 198.5 | 2.80 | 31.6 |
| Ex. 11 | V-0 | 241.7 | 1.30 | nd* |
| Ex. 12 | V-2 | 217.4 | 1.00 | nd* |
| Ex. 13 | V-2 | 179.9 | 0.47 | nd* |
| Ex. 14 | V-0 | 250.1 | 1.04 | 32.4 |
| Ex. 15 | V-0 | 246.4 | 1.80 | 32.4 |
| Ex. 16 | V-0 | 271.7 | 4.44 | 28.5 |
| Ex. 17 | V-0 | 280.1 | 1.39 | 28.3 |
| Ex. 18 | V-0 | 220.2 | 0.88 | 34.2 |
| Ex. 19 | V-0 | 254.1 | 1.17 | 29.3 |

*nd: not determined

TABLE 1
Composition (in % by weight) of the polyamide moulding compounds as per example 1

| | | Ex. 1 | Ex. 2 | Ex. 3 | Ex. 4 | Ex. 5 | Ex. 6 | Ex. 7 | Ex. 8 | Ex. 9 | Ex. 10 |
|---|---|---|---|---|---|---|---|---|---|---|---|
| PA 6.10 | | 74 | | | | | | | | | |
| PA 6.12 | | | 72 | | | | | | | | |
| PA 10.10 | | | | 74 | | | | | | | |
| PA 10.12 | | | | | 74 | 37 | | | | | |
| PA 12 | | | | | | 37 | | 74 | 74 | 75 | 76.5 |
| PA 12/6 | | | | | | | 74 | | | | |
| Fyrolflex Sol DP | Phosphate | | | | 5 | | | 5 | | 5 | |
| ADK STAB FP-600 | Phosphate | 5 | | | | 5 | | | 5 | | 10 |
| Fyrolflex RDP | Phosphate | | 5 | | | | | | | | |
| Disflamoll DPK | Phosphate | | | | | | 5 | | | | |
| Aflammit PCO 900 | Phosphonate | | | 5 | | 5 | | | | | |
| Amgard CU | Phosphonate | 5 | | | 5 | | | | | | |
| Nofia HM7000 | Phosphonate | | 5 | | | | 5 | 5 | | 5 | |
| MC | | 10 | 10 | 10 | 10 | 10 | 10 | 5 | 10 | 10 | 10 |
| Dipentaerythritol | | 5 | 5 | 5 | 5 | 5 | 5 | 5 | 5 | 5 | 3.5 |
| Stabilizer mixture | | 1 | 3 | 1 | 0 | 0 | 1 | 6 | 6 | 0 | 0 |

| | | Ex. 11 | Ex. 12 | Ex. 13 | Ex. 14 | Ex. 15 | Ex. 16 | Ex. 17 | Ex. 18 | Ex. 19 |
|---|---|---|---|---|---|---|---|---|---|---|
| PA 6.10 | | | | | | | | | | |
| PA 6.12 | | | | | | | | | | |
| PA 10.10 | | | | | | | | | | |
| PA 10.12 | | | | | | | | | | |
| PA 12 | | 74.5 | 78.5 | 73.5 | 74 | 74 | 74 | 74 | 74 | 74 |
| PA 12/6 | | | | | | | | | | |
| Fyrolflex Sol DP | Phosphate | 7.5 | 5 | | | 5 | | 8 | 2 | |
| ADK STAB FP-600 | Phosphate | | | | | | | | | 5 |
| Fyrolflex RDP | Phosphate | | | | 5 | | 5 | | | |
| Disflamoll DPK | Phosphate | | | | | | 5 | | | |
| Aflammit PCO 900 | Phosphonate | | | | | 5 | | | | |
| Amgard CU | Phosphonate | | | | | | | | | |
| Nofia HM7000 | Phosphonate | | | 10 | 5 | | | 2 | 8 | 5 |
| MC | | 10 | 10 | 10 | 10 | 10 | 10 | 10 | 10 | 10 |
| Dipentaerythritol | | 5 | 3.5 | 3.5 | 5 | 5 | 5 | 5 | 5 | 5 |
| Stabilizer mixture | | 3 | 3 | 3 | 1 | 1 | 1 | 1 | 1 | 1 |

Examples Ex. 2, Ex. 7, Ex. 9, Ex. 14 and Ex. 18 are Inventive.

Surprisingly, the examples show that, when using the aryl phosphates of the invention, the loss of mass due to migration is lower than when using higher-molecular-weight aryl phosphates containing a 4,4′-(propane-2,2-diyl)diphenylene group, especially when using aryl phosphates containing a phenylene group.

It can be seen from the examples that the desired properties in respect of flame retardancy and loss of mass due to migration are achievable only by the combination of metal-free aryl phosphate and aryl phosphonate. The combination of metal-free aryl phosphate with alkyl phosphonates is not in this context expedient.

1. A polyamide molding compound, comprising:
(A) a polyamide matrix comprising a polyamide having at least 8 carbon atoms per amide unit;
(B) a flame retardant composition comprising (B1) a metal-free aryl phosphate, (B2) an aryl phosphonate, (B3) a carbohydrate polyol, (B4) melamine cyanurate, and (B5) optionally, a non-phosphorus-comprising flame retardant,
wherein a total phosphorus content from the flame retardant composition is in a range of from 0.5 to 1.5 wt. %, based on total polyamide molding compound weight.

2. The polyamide molding compound of claim 1, wherein the polyamide comprises PA 8, PA 9, PA 10, PA 11, PA 12, PA 6.10, PA 6.12, PA 6.14, PA 8.10, PA 9.10, PA 9.12, PA 10.10, PA 10.12, PA 12.12, PA 6.16, and/or PA 10.16.

3. The polyamide molding compound of claim 1, wherein a (B1)/(B2) mass ratio is in a range of from 0.25 to 4.

4. The polyamide molding compound of claim 1, wherein the metal-free aryl phosphate (B1) comprises a first unit of formula (I): 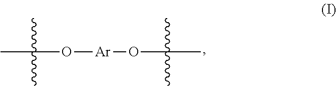
Ar being ortho-phenylene, meta-phenylene, para-phenylene, naphthylene, or biphenylene; and
a first and a second of a second unit of formula (II); 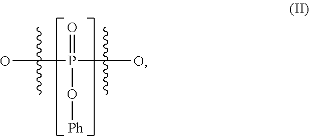
wherein the units of formula (I) or (II) are present in alternation,
wherein a number of units of formula (II) is always 1 greater than a number the first unit of formula (I),
where Ph is a phenyl radical, optionally comprising a C1 to C4 alkyl substituent.

5. The polyamide molding compound of claim 1, wherein the aryl phosphonate (B2) contains the repeat unit shown in formula (III) 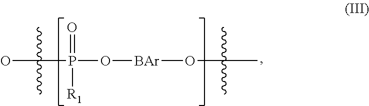
where R1 is an alkyl radical having 1 to 4 carbon atoms and
BAr is in each case independently an aromatic radical, preferably an aromatic radical having at least two rings, more preferably biphenylene or 4,4′-(propane-2,2-diyl)diphenylene.

6. A component, comprising:
the polyamide molding compound of claim 1.

7. A process for insulating one or more current-bearing components, the process comprising:
forming the polyamide molding compound of claim 1 into the current-bearing component(s) in an extrusion process or blow extrusion process, an injection-molding process or an insert molding.

8. A hybrid component, comprising:
a coated metal body,
wherein the coating comprises the polyamide molding compound of claim 1.

9. A process for transmitting an electric current, the process comprising:
allowing the electrical to pass through the hybrid component of claim 7.

10. The polyamide molding compound of claim 1, wherein a (B1)/(B2) mass ratio is in a range of from 0.33 to 3.

11. The polyamide molding compound of claim 1, wherein a (B1)/(B2) mass ratio is in a range of from 0.5 to 2.

12. The polyamide molding compound of claim 1, wherein a (B1)/(B2) mass ratio is in a range of from 0.75 to 1.5.

13. The polyamide molding compound of claim 4, comprising the first and a second of the first unit of formula (I).

14. The polyamide molding compound of claim 4, further comprising:
a first third of the second unit of formula (II).

15. The polyamide molding compound of claim 4, Ar in the first unit of formula (I) is para-phenylene.

16. The polyamide molding compound of claim 4, Ar in the first unit of formula (I) is ortho-phenylene or meta-phenylene.

17. The polyamide molding compound of claim 4, Ar in the first unit of formula (I) is naphthylene or biphenylene.
